(19) United States
(12) Patent Application Publication
(10) Pub. No.: US 2014/0008308 A1
(43) Pub. Date: Jan. 9, 2014

(54) Flexible Process Strainers

(71) Applicants: Ashley R. Guy, Houston, TX (US); Omar Angus Sites, Spring, TX (US); Sulabh K. Dhanuka, Houston, TX (US); Dag O. Calafell, II, Katy, TX (US)

(72) Inventors: Ashley R. Guy, Houston, TX (US); Omar Angus Sites, Spring, TX (US); Sulabh K. Dhanuka, Houston, TX (US); Dag O. Calafell, II, Katy, TX (US)

(21) Appl. No.: 14/004,836

(22) PCT Filed: Mar. 19, 2012
(86) PCT No.: PCT/US12/29643

§ 371 Date: Sep. 12, 2013

Related U.S. Application Data
(60) Provisional application No. 61/470,862, filed on Apr. 1, 2011.

(51) Int. Cl. B01D 35/02

(52) U.S. Cl. CPC B01D 35/02
USPC 210/767; 210/499; 210/463; 210/497.3; 210/497.01; 210/306; 210/85

(57) ABSTRACT

A strainer for removing debris from a fluid stream. The strainer includes a protective element, wherein the protective element comprises a flexible net configured to trap solids carried in a fluid stream, and a mount to hold the protective element within the fluid stream.

### CROSS REFERENCE TO RELATED APPLICATIONS

This application claims priority from U.S. Provisional Application No. 61/470,862, filed on Apr. 1, 2011, entitled Flexible Process Strainer, which is incorporated by reference herein in its entirety.

### FIELD

The present techniques relate to the use of flexible process strainers. The flexible strainers may be made from strong, chemically resistant fibers.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Strainers are generally perforated metal plates or metal screens used during the startup, commissioning, and operation of facilities to protect rotating machinery, valves, and other sensitive equipment. Strainers are intended to block the debris left behind during construction or dislodged during operation. However, they often fail themselves and may cause damage to downstream equipment.

A common issue with strainers is the decision of whether or when to take a plant shutdown to remove or replace the strainers. Running plants beyond the design life of a strainer can cause the strainer to fail due to stress caused by flow induced vibration. Strainers are generally a low cost item that have limited design data provided by manufacturers, such as flow versus expected pressure drop curves, design life predictions, or analysis for susceptibility to flow induced vibration, among others. Strainers are often placed at the suction side of rotating machinery, vessels, valves, etc. to protect internal components of the pump from damage.

Typical suction strainers include bathtub, basket, and conical types, also known as “witch-hats.” The bathtub type may have a larger surface area formed into one or more catch basins. The bathtub strainer may have a higher capacity for holding debris without fouling than a conical type, but may require a dedicated holder be inserted into a pipe section to hold the strainer. In contrast, the conical type is a circular structure that tapers to a point. Being round and smaller than the bathtub type, the conical type can fit inside a pipe, for example, taking the place of a gasket between opposing pipe flanges. Basket type strainers are cylindrical and are often mounted with the cylinder axis offset to the piping axis. Bathtub, basket, and conical type are welded designs with the bathtub strainer providing ease of removal and a conical strainer providing higher strength. The strainers are generally constructed from a punched metal mesh having finer mesh screens overlaid the punched metal.

Differential pressure (dP) may be used to determine when a shutdown should be taken to clean the strainer. The dP is usually monitored across the strainer and compared to a design pressure. However, the expected “clean” dP of current metal strainers can be unknown, which may lead to premature collapse. The limited differential pressure capability of current strainers may lead to excessive intervention and down time. Common failure modes are poor construction quality, excessive dP (static stress), and flow induced vibration (alternating stress).

Strainers can be difficult to install because of their weight and size. For example, a strainer used to replace a gasket between flanges on pipe segments may require prying apart the pipe flanges to install the strainer. Further, there may often be a shortage of readily available equipment to install strainers because of their weight and size.

Current strainers can be prone to failure and often lack design data. They are susceptible to failure in high vibration applications or when excessive differential pressure results from debris buildup. Strainers are generally designed with an open area twice that of the structural components. Their size and weight prevent them from having more open area which would yield lower “clean differential pressure” and allow them to remain installed longer.

### SUMMARY

An embodiment of the present techniques provides a flexible strainer for removing debris from a fluid stream. The flexible strainer includes a flexible net configured to trap solids carried in a fluid stream and a mount to hold the flexible net within the fluid stream.

The flexible net may include a high-strength fiber. Further, the flexible net may include an aramid, a carbon fiber, an organic polymer, an inorganic polymer, a synthetic fiber, or any combinations thereof. The flexible net may have openings between about 63 μm and about 7620 μm. The flexible net may have a protective coating configured to protect the flexible net from corrosion or degradation.

The flexible strainer can be shaped to fit into process piping. For example, the flexible strainer can be circular, cylindrical, or “D” shaped. The process piping may be equal to or larger than Nominal Pipe Size (NPS) 8. The flexible net may also be shaped like a cone, a cone with a cylindrical extension, or a rectangle. The flexible net may be collapsible and may be detachable from a mount.

The mount may include high-strength fibers, metal, a spiral wound gasket, ring gasket, or any combinations thereof. The mount may be integral to the flexible net. Further, the mount may be configured to be held between two pipe flanges, with the flexible net configured to project into a pipe segment within the fluid stream. The mount may be configured to be held within the fluid stream by being attached to support structures along an interior wall of a pipe. A deflector may protect the protective element, the mount, or both from damage.

Units may be included in the flexible net to perform other functions. For example, such units may stabilize the flexible net within the fluid stream. Sensors may be included to determine the condition of the flexible net. Imaging targets may allow non-invasive assessment of a condition of the flexible net. Aerodynamic devices may be included to stabilize the flexible net in a fluid flow. Radio frequency identity tags may be included to allow non-invasive assessment of the apparatus condition.

Another embodiment provides a system configured to remove debris from a fluid flow. The system includes a single layer of a flexible net, wherein the flexible net comprises polymeric fibers.

The flexible net may be suspended from an integral mount within a pipe spool. The system may include a gasket for a raised face flange, wherein an upper opening of the flexible net is integrated into the windings of the gasket. The system may include a spiral wound gasket, wherein an upper opening of the flexible net is integrated into the spiral wound gasket. The system may include a ring-type flange gasket, wherein an upper opening of the flexible net is integrated into the gasket. A mount may be configured to hold the flexible net by axial or radial compression.

Another embodiment provides a method for protecting equipment from debris in a pipe. The method includes placing a flexible strainer in the pipe, wherein the flexible strainer is configured to capture debris upstream of process equipment, and wherein the pipe is not designed specifically designed to hold the flexible strainer.

The equipment may comprise a pump. The method may include replacing a gasket between two pipe segments with a gasket incorporating the flexible strainer. The status of the flexible strainer may be determined by obtaining an x-ray image of the pipe.

### DESCRIPTION OF THE DRAWINGS

The advantages of the present techniques are better understood by referring to the following detailed description and the attached drawings, in which:

FIG. 1 is a cross-sectional view of a flexible strainer in a pipe;

FIG. 2 is a drawing of two examples of shapes that may be use with flexible strainers;

FIG. 3 is a drawing of a flexible strainer having a flexible net suspended from a mount within a pipe;

FIG. 4 is a front and side view of a flexible strainer which has an integrated gasket as the mount;

FIG. 5 is a drawing of two techniques for integrating a wire wound gasket with a flexible net to form a flexible strainer;

FIG. 6 is a drawing of a flexible strainer that incorporates tools for determining the status of the flexible strainer from the exterior of a pipe;

FIG. 7 is a cross-sectional view of an upstream flexible strainer configuration; and

FIGS. 7A and 7B show exemplary mounting rings.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Debris left over from construction or dislodged during operation can damage downstream equipment including compressors, pumps, valves, suction drums, heat exchangers, and the like. Embodiments described herein are directed to a flexible strainer comprising a flexible net made from high-strength fabric that can protect downstream components from debris contained in piping, vessels, or process components. The flexible net can be made from synthetic or natural polymers, and is held in place by a mount that places the flexible net in a fluid stream, for example, inside a pipe.

As used herein “flexible” has its ordinary meaning known to those skilled in the art. For example, “flexible” means capable of being flexed without breaking. In one or more embodiments, a “flexible strainer” means a strainer having a shape that can be modified or adapted without breaking. In one or more embodiments, a “flexible strainer” is a woven or unwoven mesh, cloth, web, or net of fibers.

The flexible strainer may have a higher differential pressure capability than metal strainers which allows it to accumulate more debris and run longer than a metal strainer. Further, the flexible strainer may be more resistance to overstress failure than a standard metal strainer. The flexible strainer is also less vulnerable to vibration triggered failure than a metal strainer because the fabric of the flexible net has minimal stiffness. In addition, the flexible strainer may be used to trap debris with flow going in either direction across the strainer. For example, the strainer can be structured to capture debris either in its concave or convex side.

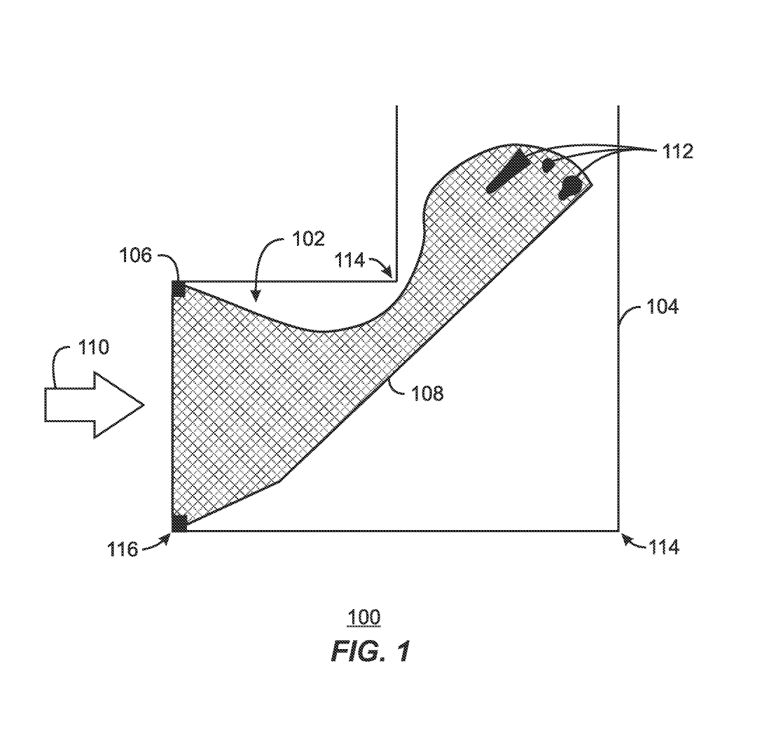

FIG. 1 is a cross-sectional view of a flexible strainer 102 in a pipe 104. The flexible strainer 102 includes a mount 106 that holds a flexible net 108 in the pipe 104, with an open end positioned in a fluid stream 110. The flexible net 108 may capture debris 112 from the fluid stream, including construction debris and process debris, such as metal fragments, broken thermowells, and the like.

The flexible net 108 can be made from high strength fibers. The fibers may be synthetic, natural, or a combination of the two and may be made from either inorganic or organic materials. High strength fibers can be stronger in tension than steel and may have a low stiffness which may make the flexible net 108 less vulnerable to cyclic fatigue stress. For example, the flexible net 108 can be formed from aramids, carbon fibers, organic polymers, inorganic polymers, synthetic fibers, or any combinations thereof. In some embodiments, the fibers may include metal wires or even metal chains. The flexible net 108 is not limited to these materials, and they may be used in combination with each other and with other materials, for example, to stiffen or strengthen the flexible net 108.

The flexible net 108 may have a protective coating configured to protect the flexible net 108 from corrosion, degradation, or physical damage. For example, the protective coating may be a polyethylene coating designed to make the flexible net more resistant to chemical attack. Other coatings may be used, including a polyphenylene sulfide (PPS), which may make the flexible net 108 more resistant to oxidative degradation. As another example, a silicone polymer coating may make the flexible net 108 more resistant to physical damage, such as sharp edges. Other materials may also be used as coatings to be for protecting a flexible net 102 from various damaging agents. For example, in some applications, a polyamide net with a polytetrafluoroethylene (PTFE) coating may be useful in environments having chemical and abrasion hazards. Further, the fibers may be chosen to be resistant to oxygen degradation, for example, being fire resistant.

The flexible net 108 may bend, allowing the flexible strainer 102 to be used in situations that a metal strainer would not be useable, such as in pipes 104 that have a bend 114 close to the installation point 116. Further, the flexible strainer 102 can be collapsible to allow fitting the flexible strainer 102 into narrow spaces such as the gap between two pipe flanges.

The flexible net 108 may have any number of mesh sizes. For example, the mesh sizes may be comparable to the mesh sizes of a metal strainer, e.g., from a size 3 mesh, which has openings of about 0.2790 in. (7087 μm) and a 70.1% open area, to a size 250 mesh, which has openings of 0.0024 in. (61 μm) and a 35.0% open area. The mesh is designed with different mesh sizes depending on the size of debris that is appropriate to flow through the strainer. Debris can range in size from grains of sand to large construction debris such as tools, boards, or scaffolding. Broken process components such as thermowells and tower internals may also occur in the fluid stream 110. Accordingly, the flexible net may have openings between about 0.0025 in. (63 μm) and about 0.30 in. (7620 μm).

In some embodiments, the flexible strainer 102 may be used to capture large debris prior to sending the fluid stream 110 through a downstream unit, such as a pump, valve, or the like. In this embodiment, the flexible net 108 may have openings of about 0.03 in. (762 μm) to about 0.3 in. (7620 μm). These embodiments may be useful in upstream lines from process filters, which generally have many layers of fine mesh to provide higher surface area, but may be vulnerable to damage or plugging from larger fragments or objects. Because the high strength fibers are lightweight in comparison to steel, larger strainers can be manufactured, which may allow for a lower pressure drop for the same amount of particulate protection as a comparable steel strainer. Accordingly, the flexible strainers 102 may be useful for larger pipe sizes, such as nominal pipe size (NPS) 8 and larger. Further, as noted, the flexibility of the flexible strainer 102 may allow it to be installed in spaces were a metal strainer of similar size cannot reach

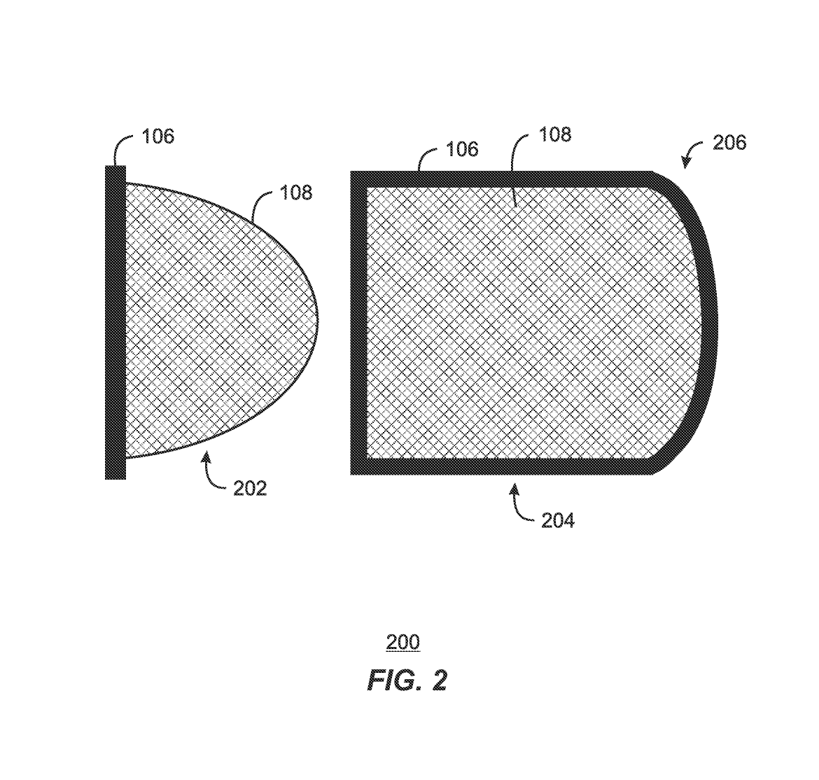

The mount 106 may not only hold the flexible net 108 open and provide an overall shape, but may also provide an attachment point to secure the flexible strainer 102 in the fluid flow 110. Many methods of attachment or shapes of the strainer design can be used, as discussed with respect to FIG. 2. The mount 106 may be made from any number of materials, including, for example, metal or high strength fibers, for example, welded into a composite structure. The mount 106 is not limited to rigid materials, but may be flexible to allow for easier installation in some applications.

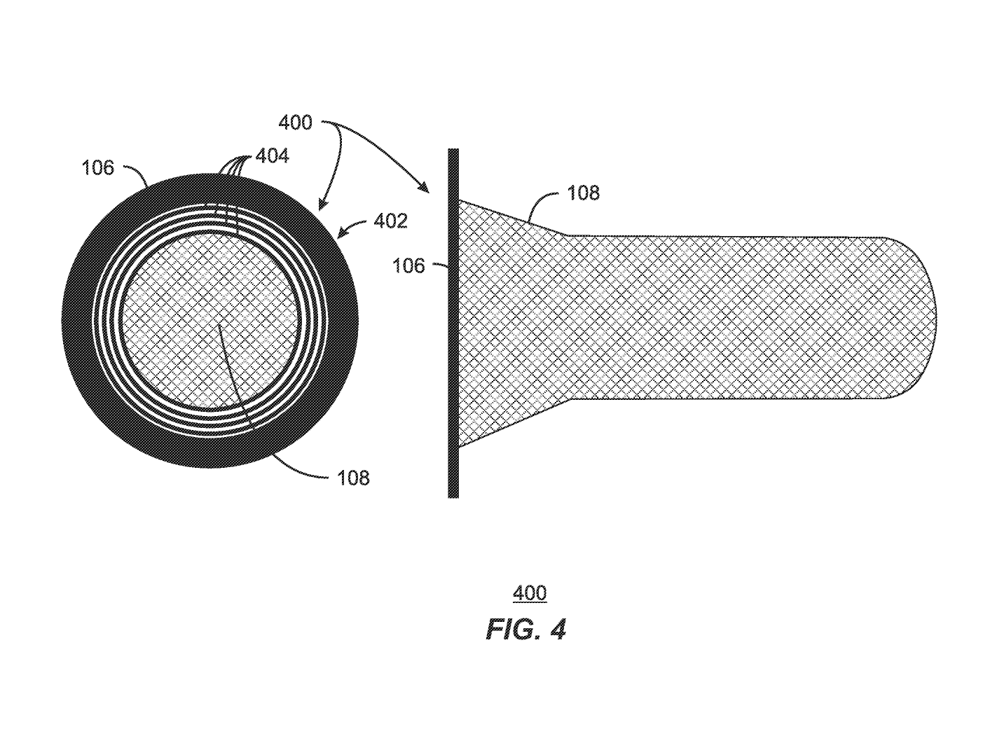

FIG. 2 is a drawing of two examples of shapes that may be use with flexible strainers. The first flexible strainer 202 is similar to that shown in FIG. 1, and may be useful for replacing metal cone strainers in some applications. This flexible strainer 202 may be installed in pipes without using a specifically designed holder, for example, as part of a gasket installed between pipe flanges, as discussed further with respect to FIG. 4.

The second flexible strainer 204 can be recognized as a “T” strainer used in a dedicated holder that is installed between pipe segments. A T strainer generally has a piping section with “porthole” that allows the strainer's replacement in the line. A flexible strainer 204 could use a much smaller porthole because the flexible strainer 204 can be squeezed into the hole. The rounded front 206 of the second flexible strainer 204 may fit against a rounded edge of a pipe wall in a holder. The flexible strainers are not limited to these configurations, as any number of other shapes may be used, including, for example, flexible strainers configured as basket strainers, Y-strainers, and the like.

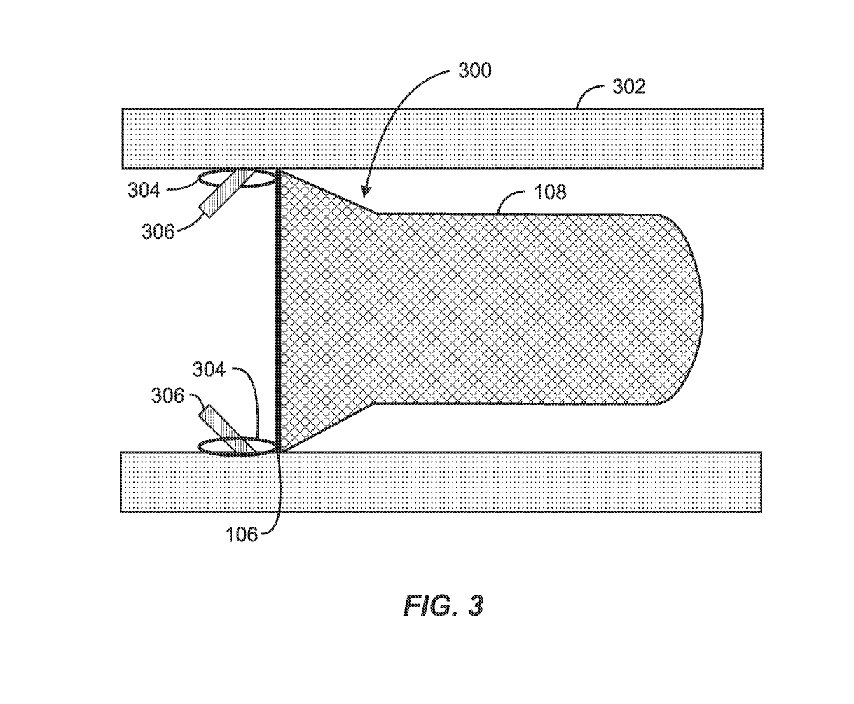

Further, the flexibility and strength of the fiber used to form the flexible nets 108 allows the flexible nets 108 to be made into different shapes. For example, a flexible strainer that is used to replace a cone strainer in a pipe installation may have a flexible net 108 shaped like a cone, a cone with a uniform diameter extension in the center of the cone (as shown in FIG. 3), a hemisphere, a parabola (as seen in flexible strainer 202), and the like. The variable geometry of the flexible strainer may be used to aid in determining when the flexible strainer is holding debris, and can be replaced. For example, a flexible net 108 having a series of extensions of decreasing diameter may provide measurement points for a pressure drop across the strainer, since the pressure may step up as each diameter of extension fills up with debris.

FIG. 3 is a drawing of a flexible strainer 300 having a flexible net 108 suspended from a mount 106 within a pipe 302. In this example, the mount 106 has rings 304 designed to fit over internal hooks 306 along the interior wall of the pipe 302. The mount 106 may be flexible to allow for easier insertion past the internal hooks 306.

In an embodiment, the internal hooks 306 can be replaced with mounting brackets having areas designed to engage with matching areas on the mount 106. In this case, the mount 106 may be more rigid to decrease the chance of the mount 106 bending and disengaging from the mounting brackets. The use of mounting brackets may allow for the use of multiple flexible strainers in series, wherein each flexible strainer can be rotated to slide past a first mounting bracket to engage with a subsequent mounting bracket. In an embodiment, each subsequent flexible strainer may have a finer mesh size. Similarly, a mount 106 may be designed to hold multiple strainers in parallel, for example, for use in a large diameter pipe.

In some embodiments above, a deflector may be used to protect the mount 106 and the flexible net 108 at the point of attachment to the mount 306. The deflectors may be used to divert the fluid stream away from the mount 106 and towards the opening in the flexible strainer. The deflectors may provide a longer useful life for the flexible strainer by lowering the chance of the flexible net 108 tearing away from the mount 106 after a debris impact.

FIG. 4 is a front and side view of a flexible strainer 400 which has an integrated gasket 402 as the mount 106. In some embodiments, the integrated gasket 402 may have bolt holes that correspond to bolt holes on the flanges. The gasket may be a configured to seal a raised face flange. In the embodiment shown in FIG. 4, the gasket 402 may have a flexible net 108 interwoven with the spiral windings 404 of the gasket material. This may help to ensure that the flexible net 108 is strongly integrated into the gasket 402. The flexible strainer 400 may then be used to replace a normal gasket between the flanges of two pipes, allowing installation of the flexible strainer 400 into the fluid flow of the pipe. As noted, the flexible net 108 may be collapsed for installation, lowering the amount of separation between the flanges during installation.

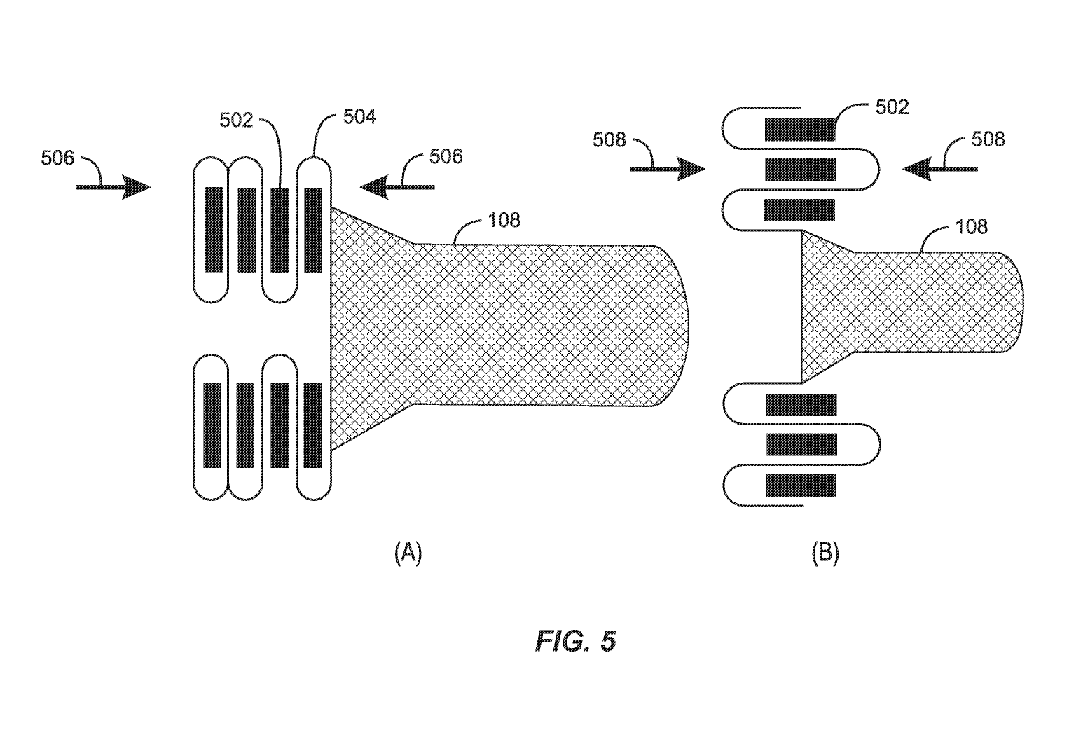

FIG. 5 is a drawing of two techniques for integrating a wire wound gasket with a flexible net to form a flexible strainer. In FIG. 5(A), the wire winding materials 502, such as graphite and a soft wire, incorporate an upper portion 504 of the flexible net 108, which is wound about the wire winding materials 502. In this example, the wire winding materials 502 and the upper portion 504 of the flexible net 108 are axially compressed by two pipe flanges, as indicated by arrows 506. In the example shown in FIG. 5(B), the wire winding materials 502 and the upper portion 504 of the flexible net 108 are radially compressed by two pipe flanges, as indicated by arrows 508. In either of the configurations shown in FIG. 5, as the wire winding materials 502 are compressed, they may flow or weld together, incorporating the upper portion 504 of the flexible net 108.

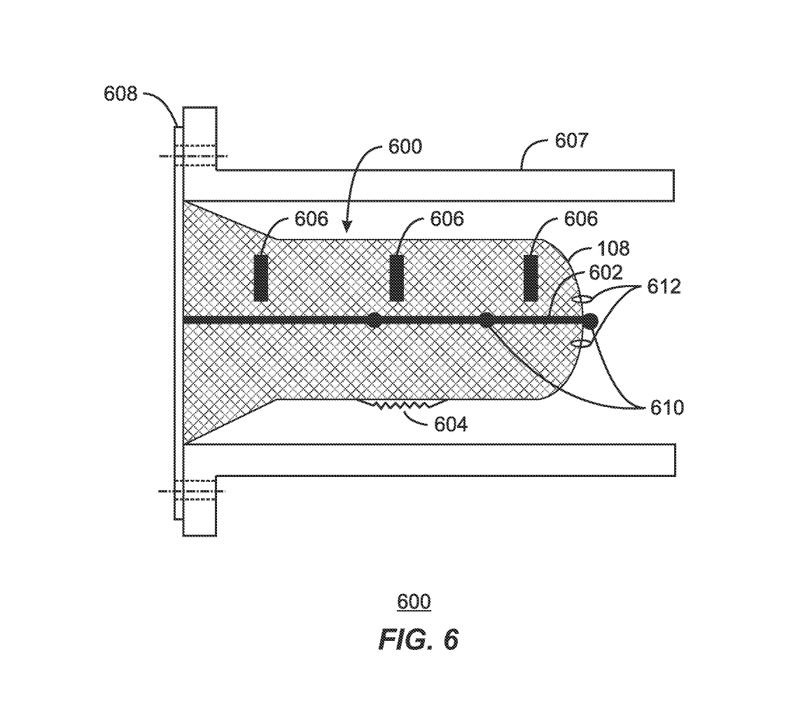

In addition to forming a flexible strainer from a gasket, other materials and tools may be incorporated into the flexible net 108. For example, the use of a polymeric fiber allows the use of x-ray imaging to determine the status of the flexible strainer. The x-rays may not clearly image the flexible strainer, but may instead image the contents. However, if the flexible strainer is not imaged, the amount of material in the flexible strainer relative to the capacity of the flexible strainer may be difficult to determine Tools may be incorporated into the flexible net 108 for this determination, as discussed with respect to FIG. 6.

FIG. 6 is a drawing of a flexible strainer 600 that incorporates tools 602, 604, or 606 for determining the status of the flexible strainer 600 from the exterior of a pipe 607. In this example, the flexible strainer 600 is formed into a gasket 608 as the mount. However, the tools may be used with any sort of mount, including, for example, the mounts discussed with respect to FIG. 2. In this example, a rod 602 may be included in the flexible net 108 to provide a gauge for the amount of debris caught in the flexible net 108. The rod 602 may have one or more spheres 610 formed at known intervals along the rod 602 to measure the debris level. Further, if the rod 602 has a sphere 610 at the end of the flexible net 108, this may provide a weight that assists in stabilizing the flexible net 108, for example, in case of shift flow rates in the fluid stream. Other stabilization devices may also be used, such as weights, or aerodynamic fins 602 that keep the flexible net 108 stable, for example, in the presence of uneven debris loads. Further, tools or devices may be incorporated to keep the flexible strainer 600 stable during flow conditions in either direction, i.e., when the flow through the strainer is from the convex or concave side.

In another embodiment, a monitoring device, such as a strain gauge 604, may be incorporated into the flexible net 604. For example, the strain gauge 604 may be a spring designed to provide an x-ray target. The spring may have a known lengthening in response to a certain applied stress and, thus, allow determination of the stress on the flexible net 102. In some embodiments, the strain gauge 604 may be an electronic strain gauge read from the outside of the pipe 607, for example, using a radio frequency identifier tag powered by the energy of the reading device.

In an embodiment, x-ray targets 606 may be attached to the flexible net 102 to show the position and amount of content of the flexible net 102. The tools and systems that may be included are not limited to those discussed above. Any number of other systems or materials may be included in the flexible net 102 for various purposes. For example, wires may be included in the weave of the flexible net 102 to provide some increase in stiffness, which may help to prevent emptying of the flexible strainer 600 during intermittent reversals in flow.

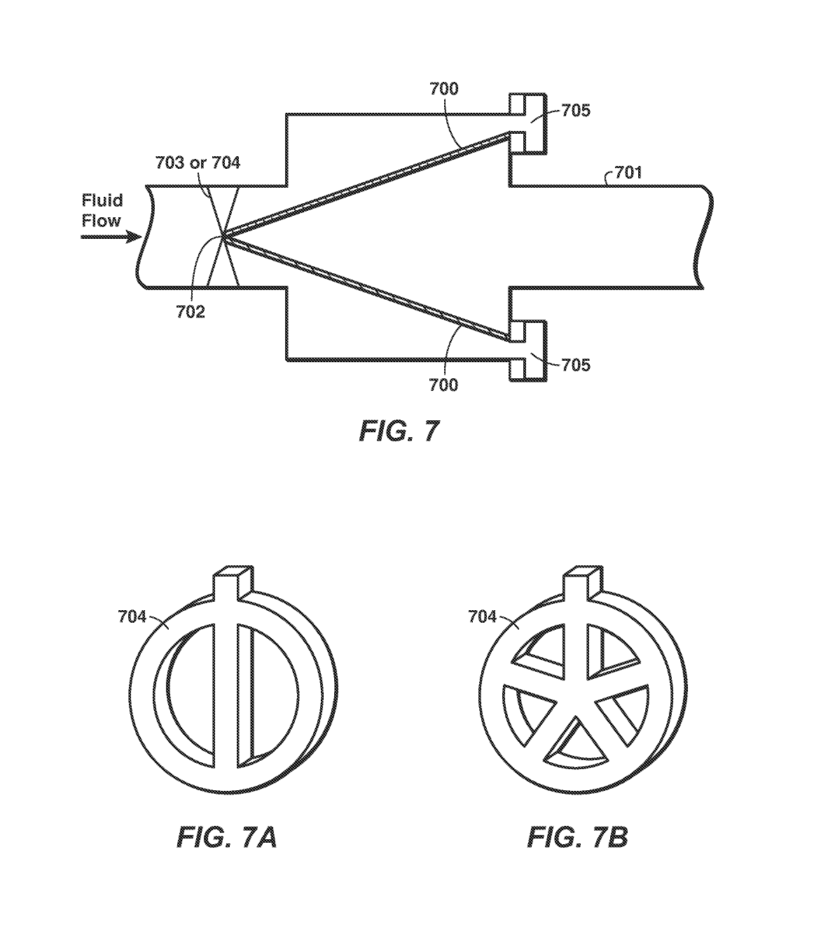

FIG. 7 is a cross-sectional view of an upstream flexible strainer configuration. Referring to FIG. 7, a flexible strainer 700 may be mounted within a pipe such that the strainer extends, or “points”, upstream, i.e., into a fluid flow. Any of the foregoing embodiments may be adapted to an “upstream” configuration.

In this configuration, the flexible strainer 700 directs debris away from the middle of the pipe where fluid travels at a maximum fluid speed, i.e., highest energy. In one or more embodiments, an “upstream” configuration reduces debris accumulation at areas of highest energy, such as at the middle of the pipe. Without being limited by theory, the upstream configuration reduces flow disruptions for downstream equipment and reduces stresses in the flexible strainer.

Flexible strainer 700 is mounted within a pipe 701 using any technique described above. In one or more embodiments, flexible strainer 700 is positioning by an internal or external rigid frame (not shown). In one or more embodiments, the cone apex 702 of flexible strainer 700 may be attached to the pipe, preferably farther upstream of the cone apex 702, by an attachment means. The attachment means includes one or more flexible guy-straps 703, wires, cables, chains, clamps, bisected or sectored ring or rings 704, etc. Exemplary rings are shown in FIGS. 7A and 7B. Such attachments means may be held in place by one or more conventional flanges or clamps (not shown). In one or more embodiments, the flexible strainer 700 may be installed in a pipe that is fabricated, forged, or cast to mount the flexible strainer.

In one or more embodiments, the flexible strainer 700 is held between a fixed circular flange (not shown) and a solid or segmented removable flange (not shown). The removable flange or segments can be held by bolts threaded into the fixed flange or by other fasteners or means with some provision for positive retention, e.g., tie-wires, thread sealant, or other means. Furthermore, these fasteners are upstream of the flexible strainer 700 and thus would not be able to migrate downstream if the retention system failed.

Preferably, flexible strainer 700 is mounted with debris collection areas 705, which may include vessels, access ports, valves, or drains, etc. for debris removal.

Preferably, the flexible strainer is mounted with one or more access flanges, doors, or compartments so that it can be serviced and replaced. The flexible strainer 700 may be replaced through the access provisions without disturbing any pipework.

While the present techniques may be susceptible to various modifications and alternative forms, the exemplary embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A flexible strainer for removing debris from a fluid stream, comprising:
a flexible net configured to trap solids carried in a fluid stream; and
a mount to hold the flexible net within the fluid stream.

2. The flexible strainer of claim 1, wherein the flexible net comprises a high-strength fiber.

3. The flexible strainer of claim 1, wherein the flexible net comprises an aramid, a carbon fiber, an organic polymer, an inorganic polymer, a synthetic fiber, or any combinations thereof.

4. The flexible strainer of claim 1, wherein the flexible net has openings between about 63 μm and about 7620 μm.

5. The flexible strainer of claim 1, wherein the flexible net has a protective coating configured to protect the flexible net from corrosion or degradation.

6. The flexible strainer of claim 1, wherein the flexible strainer is shaped to fit into process piping.

7. The flexible strainer of claim 6, wherein the flexible strainer is circular, cylindrical, or “D” shaped.

8. The flexible strainer of claim 6, wherein the process piping is equal to or larger than Nominal Pipe Size (NPS) 8.

9. The flexible strainer of claim 1, wherein the flexible net is shaped like a cone, a cone with a cylindrical extension, or a rectangle.

10. The flexible strainer of claim 1, wherein the flexible net is collapsible.

11. The flexible strainer of claim 1, wherein the flexible net is detachable from the mount.

12. The flexible strainer of claim 1, wherein the mount comprises high-strength fibers, metal, a spiral wound gasket, ring gasket, or any combinations thereof.

13. The flexible strainer of claim 1, wherein the mount is integral to the flexible net.

14. The flexible strainer of claim 1, wherein the mount is configured to be held between two pipe flanges, and the flexible net is configured to project into a pipe segment within the fluid stream.

15. The flexible strainer of claim 1, wherein the mount is configured to be held within the fluid stream by being attached to support structures along an interior wall of a pipe.

16. The flexible strainer of claim 1, comprising a deflector configured to protect the flexible net, the mount, or both from damage.

17. The flexible strainer of claim 1, comprising units configured to stabilize the flexible net within the fluid stream.

18. The flexible strainer of claim 1, comprising sensors configured to determine the condition of the flexible net.

19. The flexible strainer of claim 1, comprising imaging targets to allow non-invasive assessment of the condition of the flexible net.

20. The flexible strainer of claim 1, comprising aerodynamic devices configured to stabilize the flexible net in a fluid flow.

21. The flexible strainer of claim 1, comprising radio frequency identity tags to allow non-invasive assessment of the condition of the flexible net.

22. A system configured to remove debris from a fluid flow, comprising a single layer of a flexible net, wherein the flexible net comprises polymeric fibers.

23. The system of claim 22, wherein the flexible net is suspended from an integral mount within a pipe spool.

24. The system of claim 22, comprising a gasket for a raised face flange, wherein an upper opening of the flexible net is integrated into the windings of the gasket.

25. The system of claim 22, comprising a spiral wound gasket, wherein an upper opening of the flexible net is integrated into the spiral wound gasket.

26. The system of claim 22, comprising a ring-type flange gasket, wherein an upper opening of the flexible net is integrated into the gasket.

27. The system of claim 22, comprising a mount configured to hold the flexible net by axial compression.

28. The system of claim 22, comprising a mount configured to hold the flexible net by radial compression.

29. A method for protecting equipment from debris in a pipe, comprising placing a flexible strainer in the pipe, wherein the flexible strainer is configured to capture debris upstream of process equipment, and wherein the pipe is not designed specifically designed to hold the flexible strainer.

30. The method of claim 29, wherein the equipment comprises a pump.

31. The method of claim 29, comprising replacing a gasket between two pipe segments with a gasket incorporating the flexible strainer.

32. The method of claim 29, comprising determining the status of the flexible strainer by obtaining an x-ray image of the pipe.

33. The flexible strainer of claim 1, wherein the flexible net is mounted in an upstream configuration.

34. A system configured to remove debris from a fluid flow of claim 22, wherein the flexible net is mounted in an upstream configuration.

35. The method of claim 29, wherein the flexible strainer is mounted in an upstream configuration.
